(19) United States
(12) Patent Application Publication
(10) Pub. No.: US 2013/0060629 A1
(43) Pub. Date: Mar. 7, 2013

(54) Optimization of Content Placement

(71) Applicants: Joshua Rangsikitpho, Los Angeles, CA (US); Aaron Stein, Los Angeles, CA (US)

(72) Inventors: Joshua Rangsikitpho, Los Angeles, CA (US); Aaron Stein, Los Angeles, CA (US)

(21) Appl. No.: 13/226,654

(22) Filed: Sep. 7, 2011

(51) Int. Cl. G06Q 30/02

(52) U.S. Cl. 705/14.42

(57) ABSTRACT

Systems and methods for optimizing the placement of online advertisements based on information describing user interactions with previous advertisement. The information include primary activity data describing user responses that directly caused the previous advertisements to pay and secondary activity data describing user responses to the previous advertisements that did not directly cause the previous advertisements to pay. A performance ratings of candidate advertisements are determined based upon the primary activity data and secondary activity data. An advertisement from the candidate advertisements for the placement opportunity is selected based on their performance ratings

### BACKGROUND

The emergence of online media has created new opportunities for advertising and other content provision. Due to the differences between online media and traditional broadcast media, unique online distribution and payment methods have been developed. In an online setting, advertisers typically pay for placement of advertisements or other content based on impressions (the number of users who view the advertisement) or based on some action taken by the users. For example, according to cost-per-impression pricing (also referred to as cost-per-mille, or CPM) the advertiser pays for each time that their advertisement is shown to a user of a content distributor. Typically, a payment level is specified per one thousand or “mille” displays or impressions. According to cost-per-action (CPA) pricing, the advertiser pays only pays for an advertisement served to a user if the user subsequently takes one of a predetermined set of actions such as, for example, purchasing a product or service from the advertiser, registering with the advertiser to receive additional information about a product or service, etc. Cost-per-engagement (CPE) pricing requires an advertiser to pay each time a user interacts or engages with an advertisement. Interacting or engaging with an advertisement includes, for example, playing a game based on the advertisement, taking a poll (which may be embedded in the advertisement), mousing over the advertisement for a specified amount of time, etc.

For an online content distributor or advertising server, selecting a particular advertisement to provide to any particular user or group of users can present a considerable challenge.

### BRIEF DESCRIPTION OF THE DRAWINGS

FIG. 1 illustrates one example embodiment of a system for implementing the optimization of online advertisement placement.

FIG. 2 illustrates a flowchart showing one example embodiment of a process flow executed by the tracking engine to categorize primary and secondary activity data.

FIG. 3 illustrates a flowchart showing one example embodiment of a process flow executed by the optimization engine to optimize advertisements served in response to placement opportunities.

FIG. 4 illustrates one example embodiment of a system for implementing ad selection based user engagement to an ad.

FIG. 5 illustrates a flowchart showing one example embodiment of a process flow executed by the targeting computer system for serving to a user based on user ad engagement.

FIG. 6 illustrates a flowchart showing one example embodiment of a process flow executed by the targeting computer system select an ad for serving to a user based on user engagement with a previous ad.

### DESCRIPTION

Various example embodiments are directed to systems and methods for optimizing the placement of online advertisements or other online content (referred to herein as advertisements or simply “ads”) on publisher sites. The placements are optimized to maximize payment from advertisers (e.g., purchasers of the advertisements). Payment for the advertisements may be provided to the viewers of the advertisers by the advertisers according to any suitable online payment method including, for example, CPA, CPE, CPM, and so forth.

In various example embodiments, the optimization is based upon tracking historical user behavior with respect to advertisements. Historical user behavior is classified as either a primary activity or a secondary activity. A primary activity is a user behavior that directly and programmatically controls whether an ad or ad placement pays, that is, whether the advertiser is obligated to pay the party serving the ad for the placement of the ad on the publisher. Which user behaviors count as primary activities depends on the payment type (i.e., CPM, CPA, CPE) of ad, and can be defined by the advertiser. For CPE ads specifically, the primary activity is related to the type of CPE ad. For a quiz, poll, or survey CPE ad, the primary activity is a response (e.g., selection of one of a number of answers); for a game CPE ad, the primary activity is game play; for an open-end question CPE ad, the primary activity is an input free text answer; for a video CPE ad, the primary activity is viewing the video (or at least some minimum portion thereof). Primary activity data is data that describes the primary activity of a user with respect to an ad.

Secondary activities describe other user behavior occurring after the presentation of the advertisement (“post completion activities”) that do not directly and programmatically control whether a particular ad placement pays, but are nonetheless useful to determining the likelihood that the user will subsequently behave in a manner causing an subsequent ad placement to pay (e.g., an action or engagement). Secondary activities include visiting a web site of an advertiser, registering for an account with an advertiser, completing a web page form for an advertiser, “liking” or favoriting a page, posting, or social content associated with an advertiser, and other activities that occur after the presentation of the ad.

A placement opportunity for presenting to ad to a current user is provided, and, a performance rating is determined for each of a plurality of candidate ads for the placement opportunity. The performance rating is based on the historical user behavior for those users to whom the candidate ad (or similar ads) has been served, and who are themselves similar to the current user. The performance rating for the ad candidate ad provides a measure of the expected value of the candidate ad. A particular one of the candidate ads is selected for the placement opportunity based on its performance rating.

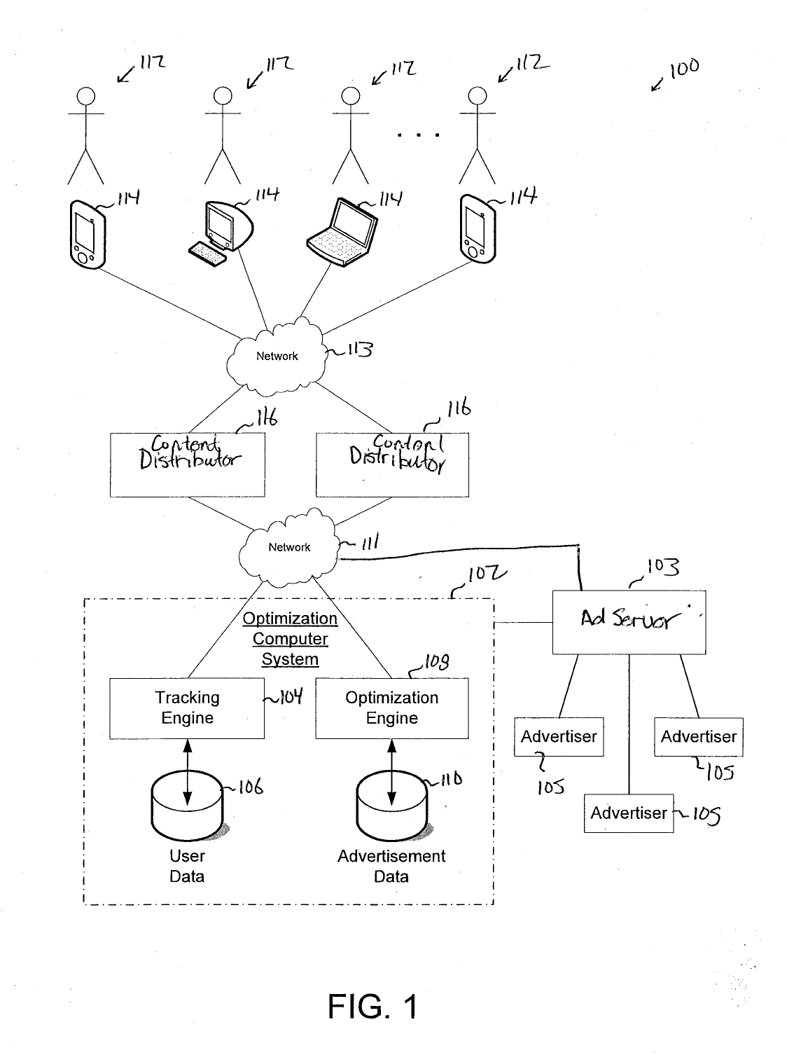

FIG. 1 illustrates one example embodiment of an environment 100 for implementing the optimization of online advertisement placement. The environment 100 includes an optimization computer system 102, content distributors 116, client devices 114, ad servers 103, and advertisers 105. The optimization computer system 102, the content distributors 116 and the client devices 114 may be in communication with one another via one or more networks 111, 113.

The optimization computer system 102 comprises a tracking engine 104, in communication with a user data store 106, and an optimization engine 108 in communication with an advertisement data store 110. The tracking engine 104 receives data from the ad server 103 identifying the primary and secondary activities of users 112 (e.g., individuals who are the intended recipients of advertisements). The tracking engine 104 stores this data the user data store 106 to update each user's profile with respect to ads they have been shown and/or interacted with. The optimization engine 108 utilizes the user data store 106 to select advertisements for particular placements opportunities. Selections by the optimization engine 108 are generally made to maximize revenue of the entity operating the optimization computer system 102, though in some embodiments, may be subject to other constraints such as, for example, cap constraints and schedule constraints, as described herein. The optimization computer system 102, as shown in FIG. 1, can be implemented by an ad server 103 or by a standalone entity operating in conjunction with one or more ad servers 103, or by a content distributor 116.

The content distributors 116 may be any type of media resource that provides, or facilitates the provision of content to the users 112. Content includes any type of web page content, video, audio, multimedia, animation, or any combination thereof. For example, content distributors 116 include websites providing news, audio, video, games, or any type of content to users as well as sites that allow users to provide content to one another for sharing such as social media sites, discussion forums, etc. Examples of content distributors 116 include social networks, social gaming providers, online music/radio services, search engines, news and information services, forum and blogs, and the like. The content provided to users may be developed by the distributor 116, purchased from other sources, or in some cases may be provided, in part, by the users 112 themselves (e.g., social media sites). Content distributors 116 may collaborate with each other to serve user content. For example, games developed by a social gaming provider may be made available to users through a social network site. Users 112 access the content distributors 116 over the network 113 utilizing user client devices 114, such as including but not limited to computers, laptop computers, tablet computers, personal digital assistants, cell phones, etc. The networks 111, 113 may be any type of wired or wireless networks configured according to any suitable communication or communications protocols. Although the networks 111, 113 are shown as separate components, it will be appreciated that one or both of them may be, utilize, and/or comprise the Internet.

In the course of providing or facilitating the provision of content to users 112, content distributors 116 may also provide ad placement opportunities. An ad placement opportunity is a spatial and/or temporal portion of content that is to be provided to a user 112 where an advertisement can be placed. Example placement opportunities include, and are not limited to ads appearing before, during, or after game play content in games; banner ads on a page of content; pre-roll, mid-roll, and post-roll ads for video or audio; ads appearing in conjunction search results. A placement opportunity or opportunities typically occurs when a user 112 requests content from a content distributor 116. The content distributor 116 may compile the requested content and determine whether a placement opportunity is to be included with the requested content. Placement opportunities within the requested content are filled with advertisements from the advertisers 105 selected by the optimization engine 108.

The advertisements are served by the ad server 103 given selection information from the optimization engine 108. An ad server 103 is operated by an entity that purchases all or a portion of placement opportunities generated by a content distributor 116 or providers (e.g., for a fixed price, for a portion of advertising revenue from the placement opportunities, etc.). The ad server 105 has programmatic access to one or databases of ads, which may be local to the ad server 103, or located at each advertiser 105, or a combination of both.

When a placement opportunity is provided to the ad server 103, the ad server 103 calls the optimization engine 108, passing in information describing the placement opportunity. The information includes the identity of the content distributor 116 site, the available dimensions (e.g., size in pixels) for the advertisement, and anonymized user identification information which allows the user 112 to be uniquely identified, but which does not expose the actual identity of the user 112. Based on the received information, the optimization engine 108 selects an ad to be provided, and provides this selection information to the ad server 103. The ad server 103 retrieves the ad from the appropriate database, and provides the advertisement to the client device 114 (e.g., directly or through the content distributor 116).

Regardless of the specific manner in which the ads are served to the user's client device 114, the content and/or ads include tracking mechanisms which provides tracking information back to the tracking engine 104. The tracking mechanism for primary activities involving the ad itself can be implemented as part of form submissions or other page elements used to provide the interactive features of the ad. For secondary activities, the tracking mechanism can be implemented using web beacons, such as tracking pixels or invisible Iframes or the like. Generally, the tracking information is configured to identify the user and describe either primary or secondary activities related to the ad or associated content. [0001] These activities generally occur during, or after the display of the content and ad on the client device 114, depending on the specific implementation of the tracking mechanism. For example, the ad server 103 may serve a CPE ad to the client device 114 that includes a survey with one or more questions. The tracking engine 104 then monitor the user's interaction with the ad based on the tracking information from the received information, and can derive additional information about the user's interaction with the ad. The tracking information for primary activities includes, for example, user responses to the ad, which can then be used to determine the amount of time taken by the user to respond, the amount of time taken by the user to complete the ad, etc.

Certain types of CPE can have multiple phases, in which particular content or information is presented in each phase, and various types of called for interactions. For example, a multi-phase ad can include a first phase having a short video clip related to an advertiser's product, and a second phase having one or more questions for the user to answer in regards to the product shown in the video. The tracking information thus includes information indicating whether the user watched the entire video (or the point at which the user stopped the video), as well as answers to the questions. Multiphase ads can have conditional or alternative phases as well, where the selection of a later phase depends on the user's response (primary activity) to a prior phase, as indicated in the tracking information. For example, a two phase CPE ad can include a short quiz, that offers to alternative “answers” (e.g., first and second answers) and second phase with two different videos (first and second videos). If the user selects the first answer in response to the quiz, the first video is shown, and if the user selects the second answer, the second video is shown. Given the variety of types of CPE ads, and the use of multiple, conditional phases, it can be appreciated that very rich CPE ads can be provided to the user.

The tracking engine 104 is also configured to track the user's secondary activities associated with the ad. Examples of such secondary activities includes, for example, visiting a webpage associated with the advertiser 105 providing the ad, “liking” or otherwise tagging a webpage of the advertiser (e.g., on a social network site, using a tagging services or sites such as DIGG, DELICIOUS, REDDIT, etc.), installing a advertiser-related application on the user device 114, installing an advertiser-related toolbar to the user device 114 (e.g., to a web browser), or accessing content related to the ad (e.g., a television program or other media). In each of these instances, suitable tracking mechanisms executing in the appropriate server domain (e.g., advertiser website, social networking site, transaction or payment processing site) or within a client side application or code, transmit the tracking information to the tracking engine 104 identifying the user and the secondary activity.

Although the interaction and tracking is described above in terms of a CPE ad, it will be appreciated that similar tracking may take place for non-CPE ads (e.g., CPA or CPM ads). For example, for a CPA ad that includes a form completion the primary activity information reported can be whether the user completed the form. For CPM ad, the primary activity can be information indicating the presentation of the ad to the user. Also, whether an activity is considered a primary or secondary activity depends on the payment method of ad for which the activity is performed. For example, a user action that would be a primary activity causing a CPA ad to pay may be considered a secondary activity if performed in response to a CPE ad. Similarly, actions that would be primary activities causing a CPE ad to pay, may be considered a secondary activity if performed in response to a CPA ad.

The user data store 106 and advertisement data store 110 comprises one or more physical storage devices. The user data store 106 stores user profile information for each user 112. The user profile information for a given user 112 includes information about the primary or secondary activities of the user. The profile information can maintain the primary and secondary activity information at either the instance level (e.g., storing the data for each ad presented to the user), or in an aggregated or rollup manner (e.g., as totals, averages, or other summarized value). Each user profile is associated with an opaque user identifier that protects the actual identity of the user 112. Example systems and methods for protecting user identities using opaque identifiers are described in commonly-owned U.S. patent application Ser. No. 13/174,238, filed on Jun. 30, 2011, which is incorporated herein by reference in its entirety.

Demographic data describing the user may also be stored in the user profile and associated with the user activity information described above. Demographic data includes, for example, the user's age, sex, geographic location, occupation, etc. Demographic data may be received directly from the user (e.g., in response to an ad, or through user registration). Optionally, the demographic data may be received from various other sources including, for example, from the content distributor 116. For example, the content distributor 116 may have demographic information about specific users that it received as part of a process whereby the user creates an account with the provider 116, or inferred from the user's activities on the content distributor's site. Also, in some cases, user demographic information may be inferred based on the content provided to the user. For example, users 112 visiting a content distributor 116 featuring content dispensing advice regarding the care of newborns may be classified as new parents. (New parents may be more likely to respond to ads for baby-related products such as formula, diapers, etc.). Also, some content distributors 116 may conduct surveys of their users indicating demographic properties. The surveys may be used to aggregate primary activity data from ads placed with the content distributors 116, for example, as described herein below. The content provider 116 can pass some of this demographic information (e.g., gender, age, location) to the optimization engine 108 via the ad server 103 when the providing the placement opportunity to the ad server 103. Data received from content distributors may supplement and/or replace data received through direct tracking of user's engagements by the ad server 103 (e.g., via the tracking engine 104).

Payment for the ad, if any, may be directed to the content distributor 116, the ad server 103 or both. In some example embodiments, one or more content distributors 116 may work directly with the advertisers 105 and may populate placement opportunities based on available advertisements received from the advertisers 105. In such example embodiments, the optimization computer system 102 may be implemented directly by the content distributor 116, eliminating the need for the ad server 103.

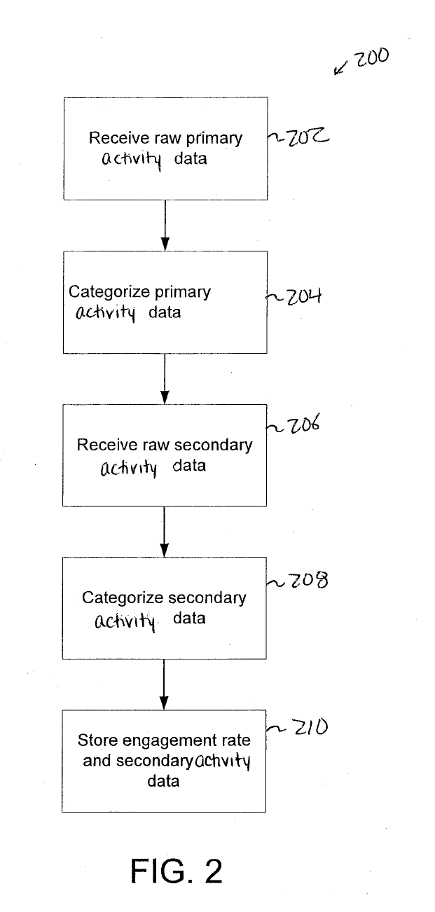

FIG. 2 illustrates a flowchart showing one example embodiment of a process flow 200 executed by the tracking engine 104 to capture and analyze historical user behavior. At 202, the tracking engine 104 accesses primary activity data vis-à-vis the tracking information, with respect to a number of ads served to users 112. The primary activity data describes the behavior of users in response to previous ads served to the users (e.g., whether the user performed the action/engagement, etc., causing the ad placement to pay). The primary activity data may be accessed from any suitable source including, for example, user devices 114, the content distributor 116 that provided the ad to a user 112, payment records to the provider 116 or the ad server 103 correlating ad placements to payments, etc. Raw primary activity data may be accessed in bulk, or may be tracked and stored over time, as described above.

At 204, the tracking engine 104 categorizes the primary activity data. Categorization involves identifying individual instances of primary activity data that match specific characteristics, and then generating summary statistics (equivalently metrics, or measures) of the primary activities with respect to those characteristics. The summary statistics include but are not limited to measures of central tendency (e.g., mean, median, mode), deviations and variances, percentiles, and correlation or dependence. The categorization can be implemented as a cross-tabulation of the primary activity data with respect to characteristics of users 112, content providers 116, advertisers 115, or ads. The categorization includes generating summary statistics for each user 112 with respect to each content provider 116, advertiser 105, and ad payment type or method. Thus, for example, for a given user 112, the tracking engine 104 can determine the percentage of CPE ad that the user responded to, and then completed.

Users may be classified at any desirable degree of specificity and, in various example embodiments, the degree of specificity used may be determined by the richness of the received raw data (e.g., the number of different types of primary and secondary activities described, the available amount and granularity of demographic data, etc.). The raw primary activity data may indicate, for each ad, the content distributor 116 providing ad placement. Accordingly, the primary activity data may be categorized by content distributor 116. For example, given a specific content distributor 116, the track engine 104 can determine the percentage or rates at which users interact with ads (e.g., answer survey questions in a CPE ad), provided through that content distributor 116. Similarly, the tracking engine 104 can determine aggregate statistics for each (or any) advertiser 105. Additionally, the tracking engine 104 can determine aggregate statistics for each (or any) partner networks through which at least a portion of the ads are served. The categorization may take place in bulk, or as individual ads are served and responses received.

As noted above, the primary activity data can be associated with user demographic information. Accordingly, demographic characteristics may be correlated to raw primary activity data, resulting in an association between the demographic profile of the users 112 and their past responses to ads. Further, the primary activity data for content providers 116 and advertisers 105 may be aggregated with respect to any combination of demographic characteristics. For example, the percentage of females, ages 20-25, in a given geographic area that provide answers to questions in survey CPE ads can be determined by the tracking engine 104.

The categorization at 204 may also include categorization by content type, ad format, presentation type, or ad type. Content type describes, for example, the products, goods, or services being promoted by the ad. Categorization may also be by ad format. Example ad formats include banner ads, videos, applets, interactive games/puzzles, etc. Presentation type describes whether the ad is a video, survey, quiz, poll, game, or open-end question.

Ad payment type describes whether the ad is a CPM, CPA, or CPE, or other payment triggering method. Categorization by payment type, with respect to individual users 112, demographic characteristics, content provider characteristics, advertiser characteristics, and the like allows the optimization engine 108 to select the best performing ad for a given placement opportunity based on the payment type as well as other factors.

At 206, the tracking engine accesses raw secondary activity data. The secondary activity data indicate additional responses of users 112 to previously received ads. Ad described herein above, these additional responses (e.g., secondary activities) do not determine whether an ad pays, but are still indicative of whether the user will respond to other similar ads in the future. The tracking engine 104 may obtain access to secondary activity information in any suitable way. For example, the ad server 103 or content provider 116 may track whether a user views certain content, “likes” a homepage, installs an application, etc. Other secondary activities may be tracked based on self-reporting from the user 112 or indirect tracking (monitoring of social media posts), etc. Suitable user privacy protections may be utilized, for example, as described herein.

At 208, secondary activity data is categorized, for example, in manner similar to the categorization of primary activity data, to generated summary statistics of the secondary activity. For example, secondary activity data may be categorized based on user demographics, ad types, etc. Users 112 may be categorized at several levels of specificity (e.g., individual users, users having common demographic properties, users of a common content distributor 116, etc. Ads may be categorized, for example, by product and/or service promoted, by ad payment type, and other available attributes.

At 210, the categorized data for primary and secondary activities (e.g., the summary statistics) with respect to individual users 112 is stored to the user data store 106. More specifically, for each user 112, the categorized data for the user 112 is stored in the user's profile in the user data store 106. In some example embodiments, the categorized data may be stored in a form searchable by the various categories such as, for example, in one or more relational databases. This allows the optimization engine 108 to quickly lookup the categorized data by any characteristic (including identifier) of any user 112, content provider 112, advertiser 105, or ad, and at any level of granularity.

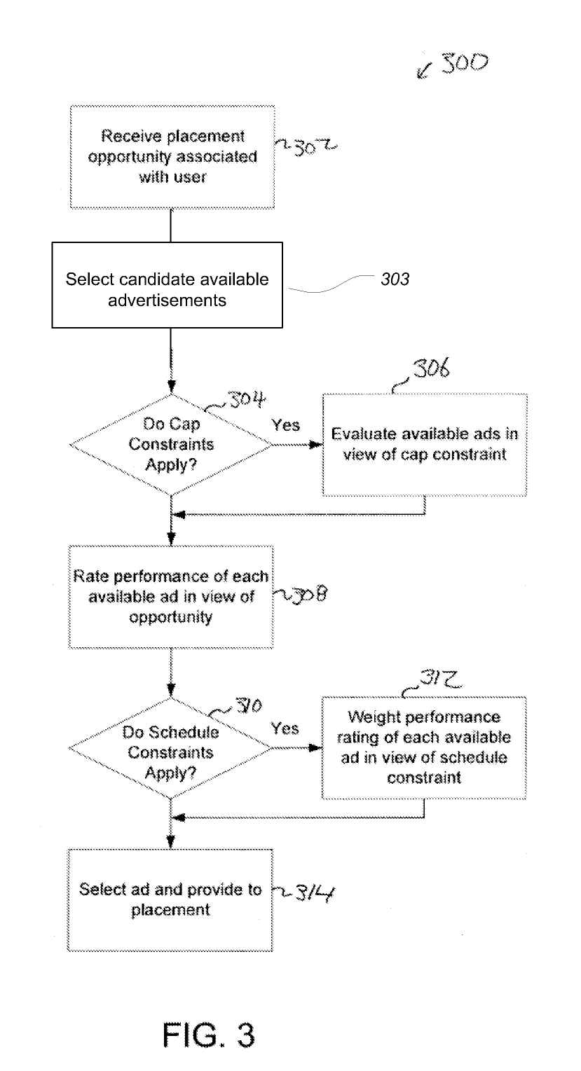

FIG. 3 illustrates a flowchart showing one example embodiment of a process flow 300 executed by the optimization engine 108 to an optimize selection of an ad for a placement opportunity based upon the categorized data produced by the tracking engine 104. At 302, the optimization engine 108 receives an indication of a placement opportunity (e.g., from a content distributor 116 or ad server 103). The placement opportunity indicates that a client device 114 has made a request for content from the content distributor 116 and that the content, when provided to client device is to include an ad. The placement opportunity include an opaque identifier of the user if available, which is then matched against the user data store 106 to obtain the user's demographic information as well as categorized primary activity data with respect to that user 112. Alternatively, the placement opportunity can itself include the user's demographic information. For example, the user device 114 associated with the user 112 comprises one or more cookies indicating, for example, past interactions between the user 112 and the content distributor 116. If the identifier of the user 112 does not match any existing identifier in the user data store 105, a new record for this user 112 is created in the user data store 106, so that the current and future interactions with the user 112 can be tracked.

At 303, the optimization engine selects a set of available candidate ads. The selection of the candidate ads can be based on an existing schedule of ads specific to the content distributor 116, bids from the advertisers 105 for the placement opportunity, or other extrinsic considerations.

At 304, the optimization engine determines whether any cap constraints apply to the placement opportunity. Cap constraints, generally, may limit the number of times that a particular ad, or ads from a particular flight or campaign, may be shown to an individual user or group of users. Cap constraints may be stipulated by the advertiser 105, the ad server 103, a content distributor 116, etc. For example, a cap constraint may specify that an advertisement may not be shown to the same user 112 more than a predetermined number of times. Another type of cap constraint may specify that the same ad may not be shown to users 112 of the same content distributor 116 more than a predetermined amount of times. In some embodiments, cap constraints may apply to a type of ad rather than just an individual ad. For example, one type of cap constraint may specify a required mix of CPE, CPA, CPM, etc. that are to be shown to a user 112 or group of users 112. Other cap constraints may limit the mix of ad types (e.g., banner ads, applets, videos, etc.) and/or the subject matter of ads that may be provided to a user 112 or users 112. Some cap constraints may be time specific. For example, such constraints may cap the number of times that an ad is shown and/or the mix of ads or ad types shown over a give time period.

If one or more cap constraints do apply, the optimization engine 108 evaluates 306 a set of available candidate ads in view of the applicable cap constraint, or constraints. The evaluation may involve determining, for each available candidate ad, whether serving that ad to the user 112 would violate a cap constraint (whether serving the ad would result in more than the threshold number of ads being provided to the user 112 or a common group including the user). Ads that cannot be served without violating the cap constraint may be removed from further consideration for the placement opportunity (e.g., ads that would violate a cap constraint may be removed from the universe of available ads).

At 308, the optimization engine 108 generates a performance rating for each available candidate ad in view of the placement opportunity. The optimization engine accesses the categorized primary activity, and secondary activity data (e.g., stored at the user data store 106) with respect to the user 112, the content provider 116, and the advertiser 105 to determine the performance rating for the ad.

In one embodiment, the performance of an available ad is based on the revenue that the ad is expected to return, using the performance of similar ads (e.g., similar subject matter, similar type, etc.) provided to user similarly to the current user 112 and a bid or other monetary value associated with the ad. Users are similar to the current user 112 if they have common or similar demographic characteristics. The performance of similar ads is then determined by further aggregating the primary activity data for these similar users from their respective user profiles, with respect to ads that are similar to the candidate ad to determine a likelihood that the candidate ad will pay. The likelihood can be a function of the user response rate for the particular type of primary activity that causes the ad to pay, dependent on the payment type of ad. Thus, when considering a candidate CPE ad, the user response rates can be determined with respect to the aggregated rates at which other similar users view a video in the ad, respond to a survey/quiz/poll, or complete the CPE ad in its entirety. For candidate CPA ad, the user response rate can be determined with respect to the aggregated rates at which other similar users perform the required action (purchasing a product or service from the advertiser, registering with the advertiser to receive additional information about a product or service, etc.). The likelihood for payment can be determined as being equal to the response, or some weighted, scaled, normalized or other derivative value.

For example, if similar users complete CPE ads similar to an available ad at a high rate, then the expected return of the CPE ad may be relatively high (e.g., close to the payment for engagement). The performance rating for the ad, then, may also be relatively high. For example, if the candidate ad is a quiz CPE and the current user 112 is a female, age 20-25, then the primary data for all females, age 20-25 for quiz CPE ads aggregated to get an overall response rate of say 65%, which is then used as the likelihood to determine the performance rating for the ad can, calculated as an expected value (e.g., expected CPM) based on the response rate and a bid for the ad. For a CPM ad, the expected revenue can be a function of a reimbursement rate per impression for the ad.

Secondary activities may also be considered in the determination of a performance rating. For example, if similar users who have a high probability of “liking” a product homepage in FACEBOOK or a similar social media application are more likely to engage a CPE ad (or perform the action causing a CPA ad to pay), then the performance rating of these ads may be increased by a weighting factor. The secondary activities (and primary activities) may be considered at any suitable level of specificity. For example, if prior data describing the same user 112 is available, it may be considered in determining the expected revenue for an ad. In some example embodiments, if the user 112 has previously performed an engagement related to a particular ad or a similar ad (primary activity), and has performed one or more secondary activities, then the ad may be given a high expected return.

The performance ratings may be calculated according to any suitable mathematical form. For example, the performance ratings may be listed as a simple percentage of similarly situated users who caused the ad to pay (e.g., by engaging a CPE ad, performing the action associated with a CPA ad, etc.). For ads that do not require user action to pay, such as CPM ads, the performance rating may be a function of the payment per impression associated with the ad. For example, a CPM ad that pays $1 per 1000 impressions may have an expected return of 1/10 of one cent. It can be seen that ads with different payment types can be selected from using the performance rating as a common, normalized measure of value. For example, CPE and CPA ads typically pay higher per engagement or action than CPM ads do per impression. If a particular user 112, or set of users situated similarly to the user 112, has a very low conversion rate for CPE and CPA ads, then the ad with the highest performance rating may be a CPM ad.

At 310, the optimization engine determines if any schedule constraints apply to the remaining available candidate ads. The schedule constraints can include a limitation on a number of times that an ad can be shown to a single user, a limitation on a number of times that an ad can be shown to users served the advertisement by a given content distributor 116; a required mix (e.g., percentage or numerical distribution) of ad types (CPM, CPA, CPE) to be served to the current user 112; and a limitation that specifies a required mix of ad formats for advertisements served to the current user 112.

Schedule constraints may relate to a time period during which particular ads must be served. For example, an advertiser may specify that an ad promoting a new movie be served to a predetermined number of paying placements a predetermined number of times before the scheduled opening date for the movie. If one of the available ads is subject to a schedule constraint, its performance rating may be weighted accordingly, at 312, to bias the ad over other ads. This may cause the optimization engine 108 to select the weighted ad over other ads that otherwise have a similar performance rating. For example, the performance rating of a first ad with a first expected revenue may be weighted to be higher than the performance rating of an ad with a higher expected revenue if the first ad is subject to a schedule constraint. The degree to which a schedule constrained ad is weighted may be determined, for example, based on the number of paying placements for the ad that have yet to be obtained and the amount of time before the deadline.

At 314, the optimization engine 108 selects one of the candidate ads for the placement opportunity based on the performance ratings of the ads. Assuming that the performance rating is computed to increase as the value of the ad increases, then the optimization engine 108 selects the candidate ad with the highest performance rating. The optimization engine then provides the selection information to the ad server 103, which serves the selected ad.

Ads (or more generally brands displayed within ads) may be selected by the optimization engine 108 for serving to particular users based on the user's responses to the ad, including information self-reported by the users in response to ads. For example, a served ad may prompt the user to engage the ad, for example, by filling out a survey, answering a multi-question quiz, playing a game, selecting a favorite sports team, or any other engagement that may tend to cause the user to provide identifying or demographically relevant information. Engaging the ad, as described may cause the ad to pay (e.g., if the ad is a cost-per-engagement (CPE) ad). In some example embodiments, though, the engagement may not cause the ad to pay (e.g., if the ad is not a CPE ad, or if the engagement occurs prior to the serving of an advertiser's brand). Results of the engagement may be utilized to select a brand to be served in the ad and/or to select subsequent ads for display to the same user 112.

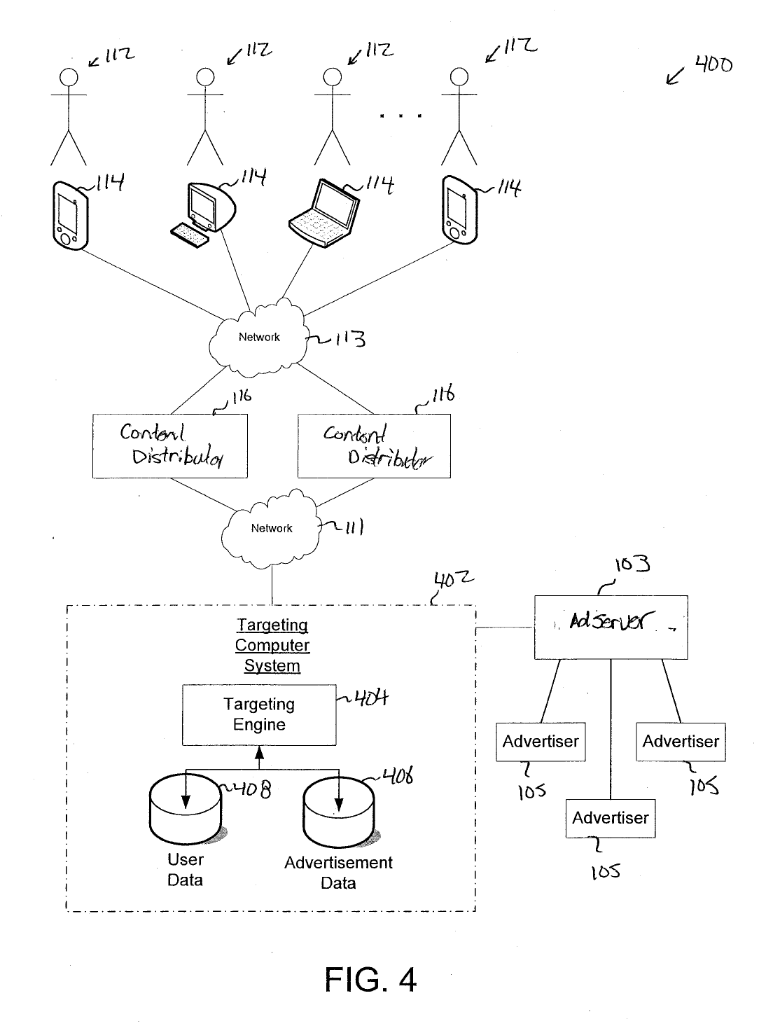

FIG. 4 illustrates one example embodiment of an environment 400 for implementing ad selection based on user's response to ads, including self-reported information. The environment 400 comprises some components in common with the environment 100 including, for example, users 112, client devices 114, content distributors 116, and networks 111, 113 as described above. In addition, the environment 400 comprises a targeting computer system 402. The targeting computer system 402 comprises a targeting engine 404 that receives and analyzes primary and secondary activity data, as described above. Such data may be stored, for example, at a user data store 408, which is similar to the user data store 108 described above as well. In response to primary and secondary activity for a current, given user 112, the targeting engine 404 may select an ad to be served to the user 112. The ad may be selected from a plurality of ads received from advertisers 105 and stored at an advertisement data store 406. The targeting computer system 404 may be implemented by an ad server 103, as described above with respect to the environment 100. The targeting computer system 402 may be implemented can be implemented by an ad server 103 or by a standalone entity operating in conjunction with one or more ad servers 103, or by a content distributor 116.

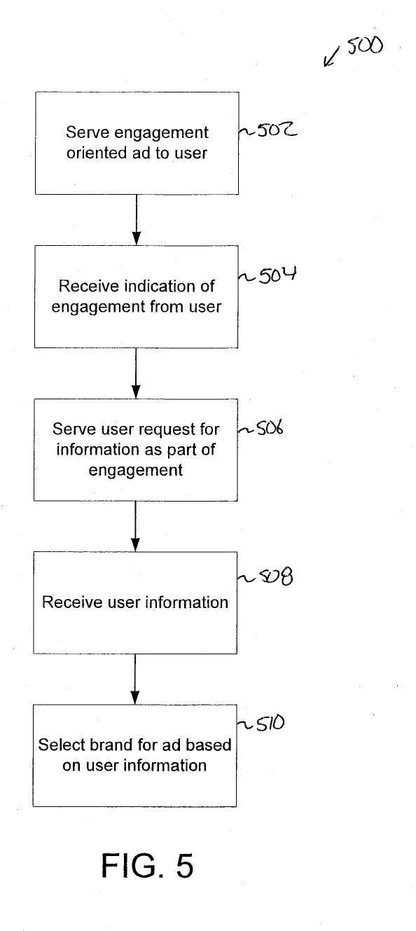

FIG. 5 illustrates a flowchart showing one example embodiment of a process flow 500 executed by the targeting computer system 402 to select an ad for serving to a user 112 based on user's responses. At 502, the targeting computer system 402 serves an ad to the user's client device 114 in response to given placement opportunity. The served ad in this embodiment is a multiphase CPE ad, but other ad types can be used. The first or initial phase(s) of ad may or may not have a specific brand appearing in it (e.g., the logo of an advertiser 105 or a particular product of the advertiser 105). For ads where the brand is not displayed in an initial phase, the brand (or other brands) can appear in ad at as part of subsequent phase depending on the user's response to the initial phase. Additionally, even where a particular brand or brands does appear in an initial phase of an ad, an additional brand or brands can appear in subsequent phases of the based on the user's responses to the initial phase during which they self-report information. For example, a first phase of an ad can include the display of a general brand encompassing many products or services (e.g. GENERAL MOTORS), along with a particular form of engagement, such as a quiz to determine the user's interest in different vehicle types. The second phase of the ad can be selected from multiple different alternatives, each with different brand related content (e.g., CHEVROLET, GMC TRUCK, BUICK, or CADILLAC) based on the user's response to the quiz. The ad can be served directly or via the ad server 105, or via the content distributor 116. The response of the user can be information about the user's interest (as in this example), or other information, including demographic information, location, attitudinal information, or the like.

At 504, the targeting computer system 402 receives an indication of engagement (e.g., response) from the user's client device 114. The indication of engagement is based upon a tracking mechanism as described above, which returns to the targeting computer system 402 an identifier of the user 112, as well as information about user's engagement with the ad. When the user 112 engages the served ad, the user 112 may interact directly with the targeting computer system 402. In some example embodiments, the content distributor 116 may serve as an intermediary between the targeting computer system 402 and the user 112. For example, the user 112 may interact directly with a server or servers of the content distributor 116. Results of the interaction may be provided by the content distributor to the targeting computer system 402.

At 506, the targeting computer system 402 serves to the user's client device 114 a request for information as part of the user's engagement (e.g., directly or via the content distributor 116). The request for information may take any suitable form. For example, the request may be a multi-question quiz, a survey, a test, a single question, etc. The user 112 may respond to the request in the context of the user's engagement with the ad. For example, if the engagement takes the form of a game, the request may be a part of the game or may be served before the game begins.

The information received from the user 112 may be any suitable type of information describing the user. In some embodiments, the request for information may be a direct request for demographic information (e.g., what is your age? where do you live?, etc.). In other embodiments, the request may be indirect. For example, if the engagement involves the user 112 playing a baseball-related game, the user 112 may be prompted to provide a favorite baseball team. From this information, the targeting engine 404 may infer the user's geographic location and/or other data. Also, for example, the engagement may involve the composing and posting a comment about the ad. The generated comment may be parsed for the information describing the user 112. In various example embodiments, user privacy may be protected, for example, as described herein above.

At 508, the targeting computer system 402 receives user information in response to the request. Again, this information may be received directly from the user 112 or, for example, through a content distributor 116. The user response may be stored and used by the targeting computer system 402 to select subsequent ads to be displayed to the same user, or to users having similar demographic properties.

At 510, the targeting computer system 402 selects a subsequent phase of the ad that includes a further brand. The selected brand may be the same as, or related to, the brand provided in the initial phase of the ad, it may be unrelated to a brand provided in the initial phase, or may complement the brand provided in the initial phase.

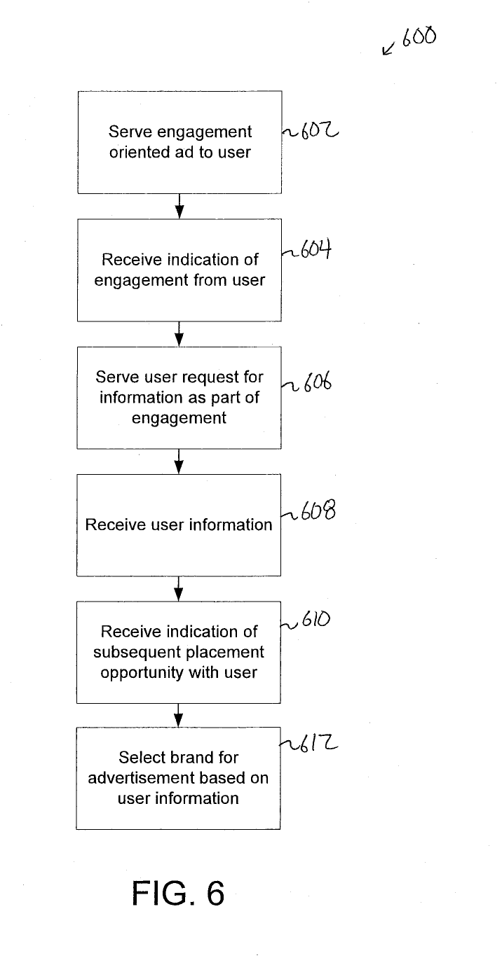

FIG. 6 illustrates a flowchart showing one example embodiment of another process flow 600 executed by the targeting computer system 402 to select an ad for serving to a user based on user engagement with a previous ad. At 602, the targeting computer system 402 serves an ad to a user 112. Again, the ad may be engagement-oriented, as described above, but it need not be a multi-phase ad. At 604, the targeting computer system 402 receives an indication that the user 112 has engaged the ad, and serves the user a request for information at 606. User information is received (in response to the request) at 608.

At 610, the targeting computer system 402 receives an indication of a subsequent placement opportunity involving the same user 112 (e.g., the user from whom user information was received at 508). The subsequent placement opportunity occur after the prior ad is served, and information received at 602, 604, 606, 608 described above.

At 612, the targeting computer system 402 selects an ad for the subsequent placement opportunity based on the user response. The ad is selected based on the brand(s) that appeared in the previously served ad at 602 and the user's response. Where the user's response to the prior ad was positive (e.g., the user responded to ad's questions, played a game, or watched a video), the selected ad is preferably one that is for the same or a related brand as in the previous ad, since the user has demonstrated some affinity or interest in the brand. Where the user's response was negative (e.g., the user did not respond or did not complete the ad), the selected ad is preferably one that is based on a different brand than that which appeared in the previous ad.

The targeting computer system 402 may combine the process flows 500 and 600. For example, the targeting computer system 402 may select both a brand for a current ad and its multiple phases, and a subsequent ad based on the received user information.

In some example embodiments, the targeting computer system 402 may be implemented in conjunction with the optimization computer system 102 described above. For example, the targeting engine 404 may be implemented by the optimization computer system 102 and/or the functionality of the targeting computer system 402 may be performed by one or both of the optimization engine 108 and the tracking engine 104 of the optimization computer system. Advertisement data may be stored at the advertisement data store 110 and user data received from users may be stored at the user data store 106.

According to various embodiments, the optimization computer system 102 comprises one or more computer devices. For example, in some embodiments, the optimization engine 108 and tracking engine 104 may represent separate hardware elements or may represent separate software modules executed by a common hardware element. Also, in some embodiments, the tracking engine 104 and optimization engine 108 may be implemented on different hardware by different parties.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The examples presented herein are intended to illustrate potential and specific implementations of the example embodiments. It can be appreciated that the examples are intended primarily for purposes of illustration for those skilled in the art. No particular aspect or aspects of the examples is/are intended to limit the scope of the described example embodiments. The figures and descriptions of the example embodiments have been simplified to illustrate elements that are relevant for a clear understanding of the example embodiments, while eliminating, for purposes of clarity, other elements. However, it should be appreciated that all of the data used herein (e.g., user responses, primary activity data, secondary activity data, etc.) are computer data as stored and manipulated by computer systems, and that similarly, all of the operations herein (e.g., as described with respect to the optimization engine 108 and tracking engine 104) are necessarily performed by computer systems, and are not performed by a human. Thus, neither the data nor the operations are to be considered mental steps or abstract ideas. Similarly, the claims set forth below do not, under any circumstances, extend to mental steps or abstract ideas.

In general, it will be apparent to one of ordinary skill in the art that at least some of the example embodiments described herein may be implemented in many different example embodiments of software, firmware, and/or hardware. The software and firmware code may be executed by a processor or any other similar computing device. The software code or specialized control hardware that may be used to implement example embodiments is not limiting. For example, example embodiments described herein may be implemented in computer software using any suitable computer software language type, using, for example, conventional or object-oriented techniques. Such software may be stored on any type of suitable computer-readable medium or media, such as, for example, solid state memory (e.g., RAM or ROM), magnetic storage media, or optical storage media. The operation and behavior of the example embodiments may be described without specific reference to specific software code or specialized hardware components. The absence of such specific references is feasible, because it is clearly understood that artisans of ordinary skill would be able to design software and control hardware to implement the example embodiments based on the present description with no more than reasonable effort and without undue experimentation.

Moreover, the processes associated with the present example embodiments may be executed by programmable equipment, such as computers, computer systems, servers, server systems, database systems, and/or processors. Software that may cause programmable equipment to execute processes may be stored in any non-transitory storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a non-transitory computer-readable medium or media that direct a computer system to perform the process steps. A computer-readable medium includes, for example, memory devices such as memory chips (RAM or ROM), diskettes, compact discs (CDs), digital versatile discs (DVDs), optical disk drives, or hard disk drives in which data and information can be stored for more than transitory periods.

Computer systems and computer-based devices disclosed herein include memory for storing certain software modules used in obtaining, processing, and communicating information. It can be appreciated that such memory may be internal or external with respect to operation of the disclosed example embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various example embodiments disclosed herein, a single component may be replaced by multiple components and multiple components may be replaced by a single component to perform a given function or functions. Except where such substitution would not be operative, such substitution is within the intended scope of the example embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer system comprises one or more processors in communication with memory (e.g., RAM or ROM) via data bus. The data bus may carry electrical signals between the processor(s) and the memory. The processor and the memory comprises electrical circuits that conduct electrical current. Charge states of various components of the circuits, such as solid state transistors of the processor(s) and/or memory circuit(s), may change during operation of the circuits.

While various example embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment. Reference to embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer-implemented system for optimizing the placement of online advertisements, the system comprising at least one processor programmed to execute an optimization engine, wherein the optimization engine is programmed to:
receive placement data indicating a placement opportunity to serve an advertisement to a client device of a user;
access available advertisement data indicating a plurality of available advertisements, wherein the available advertisements comprise advertisements that pay according to a plurality of different payment types;
access summarized, primary activity data of user responses to a plurality of previous advertisements, wherein the primary activity data is derived from user responses to the previous advertisement that directly caused the previous advertisements to pay;
access summarized, secondary activity data of user responses to the plurality of previous advertisements, wherein the secondary data is derived from user activities associated with the previous advertisements and occurring after the presentation of the previous advertisement, but that did not directly cause the previous advertisements to pay;
generate a performance rating for each of the plurality of candidate advertisements based upon the summarized primary activity data and the summarized secondary activity data; and
select an advertisement for the placement opportunity from the plurality of candidate advertisements based on the performance ratings for each of the plurality of candidate advertisements.

2. The system of claim 1, wherein the plurality of payment types comprises cost-per-engagement (CPE), cost-per-action (CPA), and cost-per impression (CPM).

3. The system of claim 1, wherein the at least one processor is also programmed to execute a tracking engine, wherein the tracking engine is programmed to:
access the primary activity data;
categorize the primary activity data into summarized primary activity data;
access secondary activity data;
categorize the secondary activity data into summarized secondary activity; and
store the summarized primary and secondary activity data to a data store.

4. The system of claim 3, wherein to categorize the primary activity data comprises to categorize based on at least one factor selected from the group consisting of:
demographic data describing the users, payment types for the previous advertisements, goods promoted by the previous advertisements, services promoted by the previous advertisements, content distributors through which the previous advertisements were served, and partner networks through which at least a portion of the previous advertisements were served.

5. The system of claim 1, wherein to generate the performance rating for each of the plurality of candidate advertisements, the optimization engine is further programmed to determine an expected revenue for the candidate advertisement.

6. The system of claim 5, wherein, to determine the expected revenue for the candidate advertisement, the optimization engine is further programmed to:
conditioned upon the candidate advertisement being a cost-per-impression advertisement, determine the expected revenue based upon a reimbursement rate per impression for the candidate advertisement.

7. The system of claim 5, wherein, to determine the expected revenue for the candidate advertisement, the optimization engine is further programmed to:
conditioned upon the candidate advertisement paying based on a primary user activity, determine a likelihood that the advertisement will pay based the summarized primary activity data for other users similar to the user for other advertisements similar to candidate advertisement paying based on the same primary user activity; and
determine the expected revenue for the candidate advertisement based upon the determined likelihood.

8. The system of claim 7, wherein, to determine the expected revenue for the candidate advertisement further, the optimization engine is further programmed to:
determine a further likelihood that the advertisement will pay based the summarized secondary activity data for other users similar to the user for other advertisements similar to candidate advertisement; and
determine the expected revenue for the candidate advertisement based upon the further likelihood.

9. The system of claim 7, wherein other users similar to the user comprise at least one of users with similar demographic backgrounds, users who were served the previous advertisements via a common content distributor, and users who were served the previous advertisements via a common partner network.

10. The system of claim 1, wherein the optimization engine is further programmed to remove from the plurality of candidate advertisements any advertisements that cannot be served to the user due to a cap constraint.

11. The system of claim 10, wherein the cap constraint comprises at least one limitation selected by the optimization engine from the group consisting of:
a limitation on a number of times that an advertisement can be shown to a single user;
a limitation on a number of times that an advertisement can be shown to users served the advertisement by a common content distributor;
a limitation that specifies a required mix of advertisement payment types for advertisements served to the user; and
a limitation that specifies a required mix of advertisement formats for advertisements served to the user.

12. The system of claim 11, wherein the required mix of advertisement payment types for advertisements served to the user comprises a distribution of cost-per-action (CPA) advertisements, cost-per-engagement (CPE) advertisements, and of cost-per-impression advertisements.

13. The system of claim 1, wherein the optimization engine is further programmed to:
determine whether a schedule constraint applies to any of the plurality of candidate advertisements, wherein the schedule constraint defines a predetermined number of paying placements of the advertisement to occur within a predetermined time; and
conditioned on a schedule constraint applying to a first advertisement selected from the candidate advertisements, apply a weight to the performance rating for the first advertisement.

14. The system of claim 15, wherein to apply the weight applied to the performance rating for the first advertisement, the optimization engine is further programmed to select the weight based on a number of previous paying placements of the advertisement resulting in payment and an amount of time remaining prior to the end of the predetermined time.

15. A computer-implemented method for optimizing the placement of online advertisements, the method comprising:
receiving placement data indicating a placement opportunity to serve an advertisement to a client device of a user;
accessing available advertisement data indicating a plurality of available advertisements, wherein the available advertisements comprise advertisements that pay according to a plurality of different payment types;
accessing summarized, primary activity data of user responses to a plurality of previous advertisements, wherein the primary activity data is derived from user responses to the previous advertisement that directly caused the previous advertisements to pay;
accessing summarized, secondary activity data of user responses to the plurality of previous advertisements, wherein the secondary data is derived from user activities associated with the previous advertisements and occurring after the presentation of the previous advertisement, but that did not directly cause the previous advertisements to pay;
generating a performance rating for each of the plurality of candidate advertisements based upon the summarized primary activity data and the summarized secondary activity data; and
selecting an advertisement for the placement opportunity from the plurality of candidate advertisements based on the performance ratings for each of the plurality of candidate advertisements.
